(19) United States
(12) Patent Application Publication
(10) Pub. No.: US 2011/0097059 A1
(43) Pub. Date: Apr. 28, 2011

(54) VIDEO PLAYBACK APPARATUS AND METHOD FOR CONTROLLING THE VIDEO PLAYBACK APPARATUS

(75) Inventors: Youhei Sekiguchi, Kawasaki-shi (JP); Atsushi Mizutome, Miura-gun (JP)

(73) Assignee: CANON KABUSHIKI KAISHA, Tokyo (JP)

(21) Appl. No.: 12/906,908

(22) Filed: Oct. 18, 2010

Related U.S. Application Data
(63) Continuation of application No. PCT/JP2009/068439, filed on Oct. 27, 2009.

(51) Int. Cl. H04N 5/783

(52) U.S. Cl. 386/343; 386/E05.003

(57) ABSTRACT

A video playback apparatus capable of adaptively setting a speed of slow playback in accordance with a frame rate of video content that is being played back and performing slow playback suitable for the video content, and a method for controlling the apparatus are provided. A playback speed determining unit refers to playback speed information for slow playback that is predetermined in accordance with values of video frame rates. The playback speed determining unit determines a playback speed used for performing slow playback on video that is currently being played back by using a frame rate of the video that is currently being played back and the playback speed information for slow playback. A decoding unit executes selection and interpolation of output frames of video data that is currently being played back and adjustment of output timing so that the video is played back at the determined slow playback speed.

This application is a Continuation of International Application No. PCT/JP2009/068439, filed Oct. 27, 2009, which is hereby incorporated by reference herein in its entirety.

### BACKGROUND OF THE INVENTION

1. Field of the Invention

The present invention relates to a video playback apparatus capable of performing special playback of video, such as fast-forward playback, and to a method for controlling the same.

2. Description of the Related Art

Recently, the frame rate of video stream data distributed in the world has become wide-ranging. For example, the frame rate of video stream data of ordinary television broadcast is 30 fps, whereas the frame rate of video stream data of broadcast for mobile terminals is 15 fps. Also, with the development of image capturing apparatuses, video content having a high frame rate, such as 240 fps or 480 fps, has been increasing.

Also, an H.264/SVC (Scalable Video Coding) technology capable of encoding video having a plurality of frame rates in one piece of video stream data has been standardized. With the use of this technology, encoding can be performed by adding video having a high frame rate, such as 480 fps, to video of standard 30 fps, for example. That is, even in one piece of video content, video having a frame rate corresponding to a display ability of a playback apparatus can be selected and played back.

A technology of adaptively controlling a playback speed in special playback of video content includes a technology of controlling a playback speed on the basis of a bit rate of video stream data (Japanese Patent Laid-Open No. 2008-227744).

Conventionally, in general display devices, a refresh rate in displaying video is 60 Hz in many cases. Recently, however, display devices that are capable of performing display at a higher speed and that are compatible with 120 Hz or 240 Hz have emerged. On the other hand, in mobile apparatuses such as mobile phones, the refresh rate is generally 30 Hz. The refresh rate indicates the number of images (frames) displayed per second.

Therefore, in the case of displaying video content of 30 fps on a display device of 60 Hz, for example, one frame is repeatedly output twice or a new frame is generated between frames in an interpolation process, whereby 30 frames per second are substantially handled as 60 frames. Since interlace signals are used in Japanese television broadcast, there are 30 even fields and 30 odd fields per second. 30 frame images per second can be generated by converting an interlace signal into a progressive signal, and furthermore, 60 frame images per second can be structured by generating interpolation frames between frames.

On the other hand, when all frames of video are displayed at the refresh rate of a display device in a case where the video has a frame rate higher than the refresh rate of the display device, the video is seen as motions slower than actual motions (this is referred to as slow motions or simply as slow). For example, in the case of displaying all frames of video of 480 fps on a display device of 60 Hz, 480 frames per second are displayed at 60 Hz in 480÷60=8 seconds, so that the video is seen as motions 8 times slower than actual motions. That is, the motions in 1 second in real time are displayed in slow motions in 8 seconds. In contrast, in the case of playing back video having a frame rate higher than the refresh rate of a display device at the speed equal to real time, the video may be displayed with frames being thinned. For example, in the case of displaying video of 480 fps on a display device of 60 Hz at the speed equal to real time, 1 frame per 8 frames may be periodically extracted and displayed.

Therefore, even if video content has a frame rate different from the refresh rate of a display device, the video content can be played back at the speed equal to real time in accordance with the refresh rate of the display device.

Furthermore, when a user desires so-called slow playback in which video content is played back in slow motions, it is preferable to execute a playback process using the characteristic of the frame rate of the video content. For example, video having a high frame rate, which has a characteristic in that the number of frames per unit time is large, can be applied to slow playback that is finer and smoother compared to video having a typical frame rate. In contrast, video having a low frame rate has a small number of frames per unit time, and is thus seen as frame-by-frame video having no almost change in video even if the speed of slow playback is decreased.

However, a slow playback function of a current video playback apparatus forces a user to perform playback at a predetermined playback speed regardless of a difference in frame rate of video itself. In the current slow playback function, slow playback at ½× speed is merely executed when a slow playback button is pressed. Otherwise, in the other slow playback function, user can sequentially switch between fixed values such as ½× speed, ⅛× speed, 1/16× speed, etc. regardless of a difference in frame rate of video itself. That is, the frame rate of video itself is not taken into consideration for determining a slow playback speed in the current video playback apparatus.

Additionally, the technology disclosed in Japanese Patent Laid-Open No. 2008-227744 controls a playback speed in special playback, but the bit rate of video data is referred to for controlling the playback speed, and control based on the frame rate is not performed.

### SUMMARY OF INVENTION

Accordingly, an object of the present invention is to provide a video playback apparatus capable of adaptively setting a speed of slow playback in accordance with the frame rate of video content that is being played back and performing slow playback suitable for the video content, and a method for controlling the same.

According to an aspect of the present invention, there is provided a video playback apparatus capable of performing a slow playback process on video data accumulated in an accumulation unit. The video playback apparatus includes a detecting unit that detects a value of a frame rate of video data, a determining unit that determines, on the basis of the value of the frame rate detected by the detecting unit, a slow playback speed used for performing slow playback on the video data having the frame rate, and a playback unit that executes a slow playback process on the video data by using the slow playback speed determined by the determining unit.

Also, according to another aspect of the present invention, there is provided a method for controlling a video playback apparatus capable of performing a slow playback process on video data accumulated in an accumulation unit. The method includes steps of detecting a value of a frame rate of video data, determining, on the basis of the detected value of the frame rate, a slow playback speed used for performing slow playback on the video data having the frame rate, and executing a slow playback process on the video data by using the determined slow playback speed.

Further features of the present invention will become apparent from the following description of exemplary embodiments with reference to the attached drawings.

### BRIEF DESCRIPTION OF DRAWINGS

FIG. 1 is a block diagram illustrating a configuration of a video playback apparatus according to the present invention.

FIG. 2 is a flowchart according to a first embodiment of the present invention.

FIG. 3 is a diagram illustrating playback speed information according to the first embodiment of the present invention.

FIG. 4 is a flowchart according to a second embodiment of the present invention.

FIG. 5 is a diagram illustrating a data structure of H.264/SVC according to a third embodiment of the present invention.

FIG. 6 is a diagram illustrating playback speed information according to the third embodiment of the present invention.

FIG. 7 is a flowchart according to the third embodiment of the present invention.

### DESCRIPTION OF THE EMBODIMENTS

Hereinafter, embodiments of the present invention will be described with reference to the drawings.

### First Embodiment

### Configuration of Video Playback Apparatus 100

A first embodiment of the present invention will be described. A video playback apparatus according to this embodiment is an apparatus for playing back video that is displayed on a display panel having a refresh rate of 60 Hz. Specifically, a description will be given under the assumption that the apparatus is a television set including a video recording/playback unit. Of course, the video playback apparatus according to the present invention may be a broadcast recorder having a configuration separated from a display panel.

Video content to be played back is stream data in an MPEG2 TS (Transport Stream) format. In the stream data of MPEG2 TS, video data encoded with H.264/SVC and audio data are multiplexed. Assume that video data encoded with H.264/SVC includes video data having a frame rate of 30 fps and video data having a frame rate of 480 fps that are hierarchically encoded. H.264/SVC is an already-known technology, and thus the description thereof is omitted here.

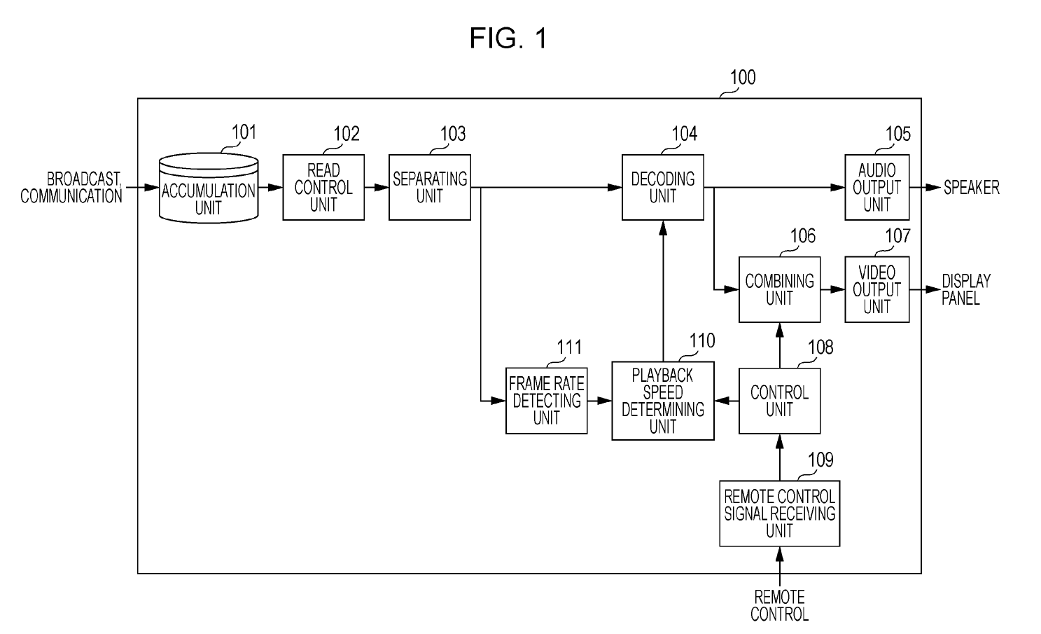

FIG. 1 is a block diagram illustrating a configuration of the video playback apparatus 100 according to the first embodiment. An accumulation unit 101 accumulates stream data serving as video content. The stream data is received through broadcast or communication and is accumulated in the accumulation unit 101.

A read control unit 102 reads stream data of MPEG2 TS accumulated in the accumulation unit 101 and outputs it to a separating unit 103. The separating unit 103 separates video stream data and audio stream data from each other in the stream data input thereto, and outputs the video stream data and the audio stream data to a decoding unit 104. Also, the separating unit 103 outputs the same video stream data as the video stream data output to the decoding unit 104 to a frame rate detecting unit 111.

The decoding unit 104 decodes the video stream data and the audio stream data input thereto and outputs the decoded video data to a combining unit 106 and the decoded audio data to an audio output unit 105. The decoded video data output from the decoding unit 104 is video data in units of frames. The decoding unit 104 controls the frame rate of the video data in units of frames to 60 fps so that the frame rate is synchronized with the refresh rate of a display panel. The frame rate related to playback of the video output from the decoding unit 104 (referred to as playback frame rate) is always constant regardless of the frame rate of the input video data and the playback speed of the video data. In contrast, the frame rate of video data originally held by the video input to the decoding unit 104 (referred to as video frame rate) varies depending on video content.

The audio output unit 105 outputs the decoded audio data to a speaker. The speaker may be included in the video playback apparatus or may be separated therefrom.

The combining unit 106 executes a process of combining graphics data, such as a menu screen output from a control unit 108, with the decoded video data as necessary. Of course, when it is unnecessary to combine graphics data, the decoded video data passes through the combining unit 106. A video output unit 107 outputs the video data output from the combining unit 106 to the display panel.

The control unit 108 is a control unit, such as a CPU that controls the entire video playback apparatus 100. Particularly, the control unit 108 controls generation of graphics data, such as a menu presented to a user, in accordance with an instruction from the user or an internal state of the video playback apparatus 100. Also, the control unit 108 executes a process of generating graphics data and outputs the generated graphics data to the combining unit 106.

In a slow playback operation described below, the control unit 108 notifies a playback speed determining unit 110 that a slow playback button has been pressed after a user has pressed the slow playback button provided in a remote control. For a simple description, the control unit 108 is connected to only the combining unit 106 and the playback speed determining unit 110 in FIG. 1, but the control unit 108 is also connected to the other functional units via a signal line not illustrated.

A remote control signal receiving unit 109 receives a remote control signal that is input when a user operates the remote control and that corresponds to an operation instruction from the user.

The playback speed determining unit 110 determines the playback speed of video data and outputs a control command indicating the determined speed to the decoding unit 104.

The frame rate detecting unit 111 analyzes video data input from the separating unit 103 and detects a value of an input video frame rate. A process of detecting a value of a video frame rate executed by the frame rate detecting unit 111 will be described below.

The value of the video frame rate detected by the frame rate detecting unit 111 is input to the playback speed determining unit 110. The playback speed determining unit 110 outputs a control command indicating a playback speed to the decoding unit 104 in accordance with the value of the video frame rate input thereto. When a user inputs an instruction about special playback, such as fast-forward, fast-rewind, or slow playback, via the remote control, the playback speed determining unit 110 receives a control signal corresponding to the input of the instruction from the control unit 108 that has received the input of the instruction. Then, the playback speed determining unit 110 determines a playback speed corresponding to the instruction from the user by using the received input of the instruction, the video frame rate, and information about a current playback speed, and outputs it as a control command to the decoding unit 104.

### Process of Playing Back Video Data Using Video Playback Apparatus 100

Next, a description will be given about an operation of playing back video data using the above-described video playback apparatus 100.

As described above, assume that stream data of video content received through broadcast or communication is accumulated in the accumulation unit 101. When a user provides an instruction to play back video content via the remote control, the control unit 108 instructs the read control unit 102 to read the video content specified by the user from the accumulation unit 101 in response to the instruction. The read control unit 102 reads transport stream data of the specified video content from the accumulation unit 101 on the basis of the instruction from the control unit 108 and outputs it to the separating unit 103.

The separating unit 103 executes a process of separating video stream data and audio stream data from each other in the transport stream data input thereto. The video stream data separated by the separating unit 103 is input to the decoding unit 104 and the frame rate detecting unit 111.

The frame rate detecting unit 111 analyzes the video stream data input thereto and detects the frame rate of the video stream data. The value of the detected video frame rate is input to the playback speed determining unit 110.

The playback speed determining unit 110 refers to the value of the video frame rate input thereto and input of an instruction about a playback speed from the control unit 108 and transmits a control command indicating a playback speed to the decoding unit 104.

For example, in a case where the frame rate of the video stream data is 60 fps and where an instruction about special playback is not input from the control unit 108 as a result of analysis on the video stream data, it can be determined that the user desires playback at the speed equal to the speed in real time. Thus, video data may be displayed at 1× speed in order to play back the video data having a video frame rate of 60 fps at the speed equal to the speed in real time on a display panel having a refresh rate of 60 Hz. Then, the playback speed determining unit 110 transmits a control command for displaying the video data of 60 fps at 1× speed to the decoding unit 104.

In response to the control command transmitted from the playback speed determining unit 110, the decoding unit 104 decodes the video stream data into video data in units of frames and plays back the decoded frame images at the specified playback speed. Also, the decoding unit 104 outputs the played back video data to the combining unit 106. In the case of displaying the video data of 60 fps at the speed equal to the speed in teal time, 60 frames may be output per second without a process of thinning decoded frame images or repeatedly outputting frame images. That is, in this case, the video frame rate matches the playback frame rate and the playback speed is 1× speed, and thus a process of thinning or interpolating frames is unnecessary.

On the other hand, in the case of playing back video having a frame rate of 480 fps at the speed equal to the speed in real time and displaying the video, 480 frames per second cannot be output as is. Thus, the decoding unit 104 extracts 60 frames from 480 frames per second and outputs the 60 frames to the combining unit 106. Therefore, in order to play back video data of 480 fps at the speed equal to the speed in real time, the playback is performed at 8× speed compared to the case of displaying all frames at 60 Hz.

Additionally, in a process of extracting 60 frames, 1 frame is simply extracted from every 8 frames, whereby 60 frames can be extracted from 480 frames at regular intervals. However, when such a simple method is used, motion information in seven frames existing between extracted frames is lost, so that the video is displayed in frame-by-frame advance. Then, in order to prevent missing of motion information, the decoding unit 104 may generate 60 frames from 480 frames by interpolation. As a generation method used in this case, various techniques about generating frames that store motion information can be used.

### Control of Slow Playback Speed During Playback of Video

Next, a description will be given about control during a slow playback process, which is a characteristic process of the present invention. Note that the slow playback process in the present invention includes a reverse in a rewind direction (backward direction) in addition to an advance in a playback direction (forward direction). Also, in this embodiment, slow playback has two selections of ON and OFF. When slow playback is turned OFF, playback is performed at the speed equal to real time. A selection between ON and OFF of slow playback is performed by pressing a slow playback button of the remote control. That is, when the slow playback button is pressed during slow playback, control for turning OFF slow playback is executed.

Also, it is assumed that video content that is being played back is encoded with the above-described H.264/SVC standard, and that video data having two types of frame rates, 480 fps and 30 fps, is included as video data.

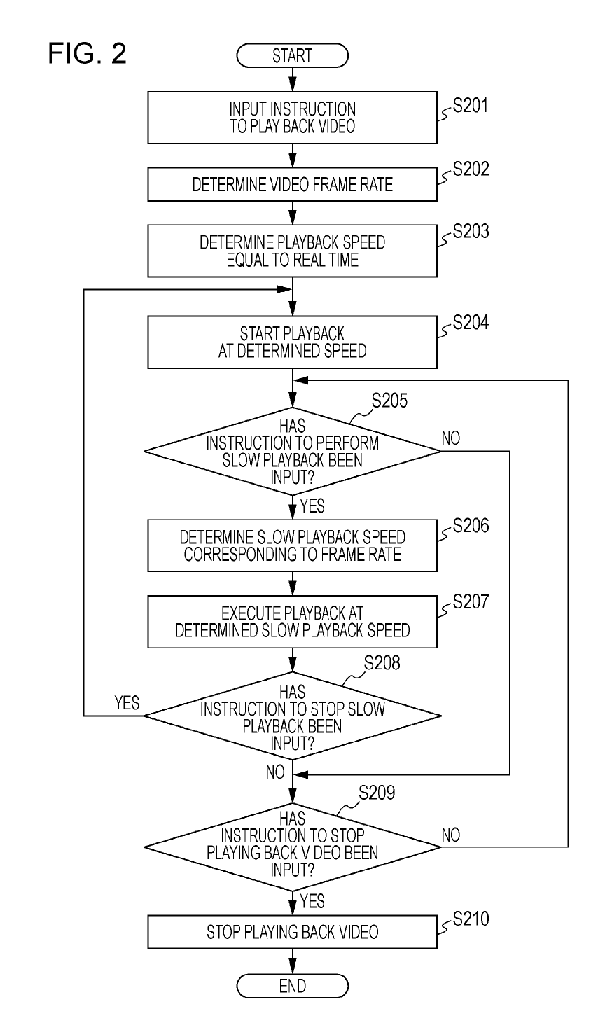

FIG. 2 is a flowchart illustrating control during a process of playing back video content.

First, in step S201, a user selects video content accumulated in the accumulation unit 101, and inputs an instruction to play back the selected video content to the remote control, whereby the control unit 108 receives the instruction to play back the video output from the remote control signal receiving unit 109. Accordingly, the control unit 108 recognizes that the playback button of the remote control has been pressed.

Subsequently, the video frame rate of the video content that is specified to be played back is determined. When the video content is not content in the form of H.264/SVC or the like and is video content having a general single frame rate, the frame rate of the video content itself is used as the video frame rate. For example, when the video content has a single frame rate of 60 fps, the video frame rate is naturally 60 fps. On the other hand, in the case of video content of H.264/SVC, video data having a plurality of frame rates is encoded and thus it is necessary to select a video frame rate to be decoded. Various methods can be used to select a video frame rate, but a method for causing a user to select a video frame rate is used to determine a video frame rate to be decoded in this embodiment. The frame rate of video content can be obtained by referring to header information of video data of H.264/SVC by the frame rate detecting unit 111. The control unit 108 generates a UI for selecting a frame rate by using information about this frame rate and causes the display panel to display it via the combining unit 106. The user selects a video frame rate to be decoded via the displayed UI.

After the video frame rate has been determined, the process proceeds to step S203. In step S203, the playback speed determining unit 110 determines a playback speed equal to the speed in real time on the basis of the value of the video frame rate. As described above, in the case of video content having a video frame rate to be decoded of 60 fps in the display panel of 60 Hz, the playback speed which is the speed equal to real time is 1× speed. On the other hand, in the case of video content of 480 fps, the playback speed which is the speed equal to real time is 8× speed.

In step S204, the playback speed determining unit 110 notifies the decoding unit 104 of the determined playback speed. The decoding unit 104 constitutes frame images obtained by decoding video stream data in 60 fps corresponding to the refresh rate of the display panel so as to realize the specified playback speed, and outputs them to the combining unit 106.

In step S205, the control unit 108 determines whether an instruction of slow playback is input from the user during playback of video at the speed equal to real time. When determining that an instruction of slow playback is input (Yes in step S205), the control unit 108 notifies the playback speed determining unit 110 of that fact.

In step S206, the playback speed determining unit 110 refers to playback speed information of slow playback that is predetermined in accordance with the values of video frame rates and performs a process of determining a playback speed corresponding to the value of the corresponding frame rate.

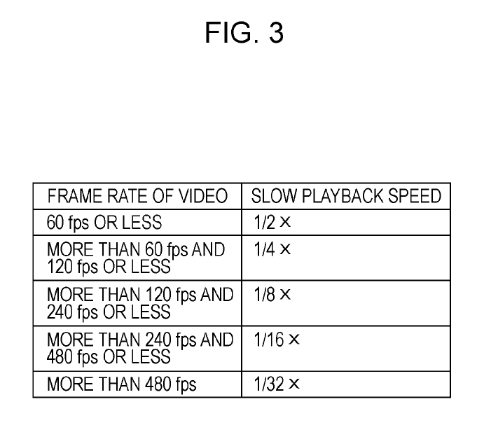

FIG. 3 is a diagram illustrating the outline of the playback speed information. The playback speed information is information that is stored in a storage unit (not illustrated). In the playback speed information, a plurality of types of playback speeds in slow playback are associated with respective values of a plurality of video frame rates that are assumed to be available in video that can be played back by this video playback apparatus. Note that the playback speeds indicate multiplying factors of speed in a case where the speed equal to real time is 1× speed. The playback speed determining unit 110 determines a playback speed at which slow playback is to be performed on video that is currently being played back by using the value of the frame rate of the video that is currently being played back and the playback speed information of slow playback stored in the storage unit.

The reason for varying a playback speed of slow playback in accordance with a difference in video frame rate to be decoded is as follows. Video having a high video frame rate, e.g., video data of 480 fps, has a larger number of frames per unit time compared to that of video having a low video frame rate, e.g., video data of 30 fps. Therefore, in the case of performing slow playback, video having a higher frame rate is suitable for playback at a low speed. This is because frames exist at shorter intervals in video having a larger number of frames per unit time, and that inter-frame video can be smoothly played back even when the video is played back at a low speed. With smoother slow playback at a lower speed, a user can see video of a moment that is invisible in slow playback at a general speed. In other words, if slow playback is performed at a constant slow playback speed regardless of a difference in frame rate, a merit of a high frame rate of video that is being played back cannot be sufficiently utilized.

Naturally, even if video having a low video frame rate is played back at an extremely low slow playback speed that is the same as that for a high frame rate, display of smooth slow playback cannot be realized because the original number of frames is small. That is, by performing slow playback by using an appropriate slow playback speed according to a difference in video frame rate, slow playback video that is more attractive for a user can be presented.

In a case where the value of a video frame rate of video that is currently being played back is 60 fps, ½× speed with respect to real time is specified as a playback speed at the time of slow playback in the playback speed information. Then, the playback speed determining unit 110 transmits, to the decoding unit, a control command for providing an instruction to perform playback at ½× speed. That is, 60 frames are played back in two seconds, and thus 1 frame is repeatedly displayed twice. In a case where the value of a video frame rate of video that is being played back is 480 fps, the playback speed determining unit 110 transmits, to the decoding unit, a control command for providing an instruction to perform playback at 1/16× speed with respect to real time. Video having a frame rate of 480 fps is played back at 8× speed as the speed equal to real time. Thus, when the video is played back at 1/16× speed with respect to real time, which means the video is played back at ½× speed. This corresponds to displaying 480 frames per second in 16 seconds, and 1 frame is repeatedly displayed twice.

In step S207, the decoding unit 104 executes selection and interpolation of output frames of video data that is currently being played back, and adjustment of output timing so as to realize the playback speed that is notified of using the control command transmitted from the playback speed determining unit 110. Accordingly, the slow playback video corresponding to the video frame rate can be adaptively provided to the user.

In step S208, the control unit 108 determines whether an instruction to stop slow playback has been input via the remote control or not. If the control unit 108 determines that an instruction to stop slow playback has been input, the process returns to step S204, where a control command is issued to the decoding unit 104 so as to perform switching to playback at the playback speed determined by the playback speed determining unit 110 in step S203.

In step S209, the control unit 108 determines whether an instruction to stop playback of the video is input during slow playback or during playback at the speed equal to real time or not. If the control unit 108 determines that an instruction to stop playback of the video has been input, the control unit 108 provides an instruction to stop playback of the video to individual functional units, such as the read control unit 102 and the decoding unit 104, and executes control so that no video is displayed on the display panel.

With the above-described process, the speed of slow playback is adaptively set in accordance with the frame rate of video content that is being played back, so that slow playback suitable for the video content can be performed.

### Second Embodiment

Next, a second embodiment of the present invention will be described. In the above-described first embodiment, a preferable slow playback speed is predetermined in accordance with the video frame rate of video data, and slow playback is performed by setting a slow playback speed in accordance with the value of the video frame rate of the video that is being played back at the execution of slow playback.

In contrast, this embodiment is characterized by performing slow playback by selecting video data having a video frame rate that is more suitable for slow playback at the execution of slow playback of video data in which a plurality of video frame rates can be freely selected. An example of video data in which a plurality of video frame rates can be freely selected includes video data that is encoded in the H.264/SVC standard, but this embodiment is not limited thereto. For example, two independent video streams having different frame rates may be played back while switching therebetween by synchronizing the playback positions thereof. In any case, the video playback apparatus according to the second embodiment is an apparatus capable of playing back video data having any one video frame rate among a plurality of pieces of video data having the same content and different values of video frame rates.

The configuration of the video playback apparatus according to the second embodiment is similar to the configuration of the video playback apparatus according to the first embodiment illustrated in FIG. 1, and thus the description thereof is omitted.

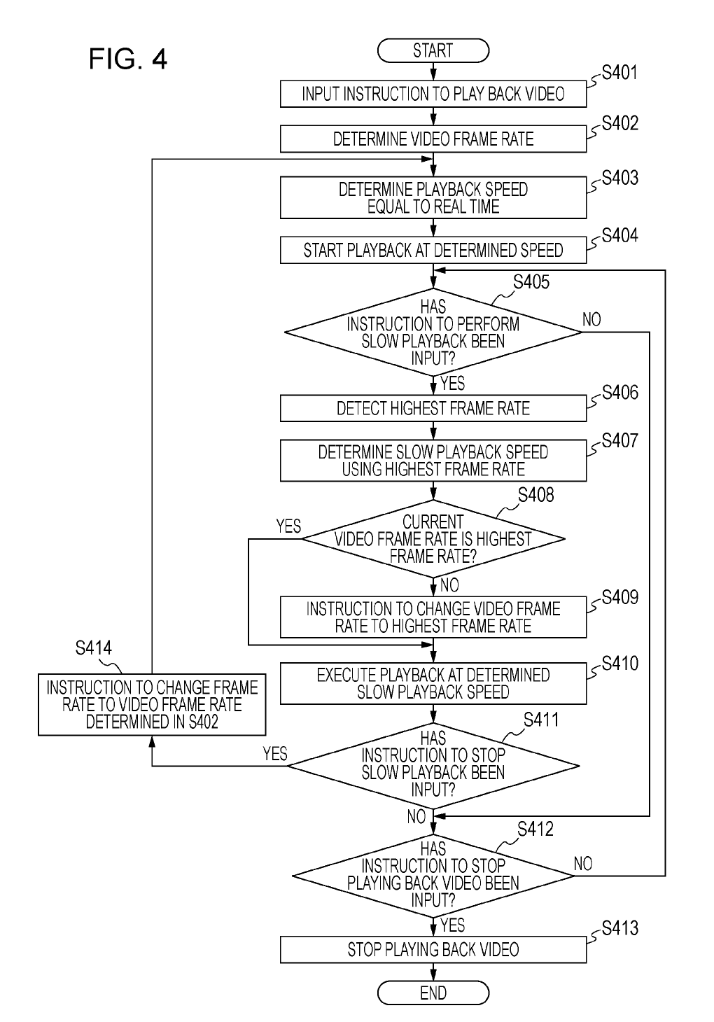

FIG. 4 is a flowchart illustrating control in a process of playing back video content according to the second embodiment.

The control in steps S401 to S405 is equal to that in steps S201 to S205 in the flowchart in FIG. 2 according to the above-described first embodiment, and thus the description thereof is omitted.

In step S406, the frame rate detecting unit 111 detects the value of the highest video frame rate in video content that is being played back. Substantially, frame rate information is detected in step S402, and thus it is preferable to store a detection result at the time and use the information in step S406.

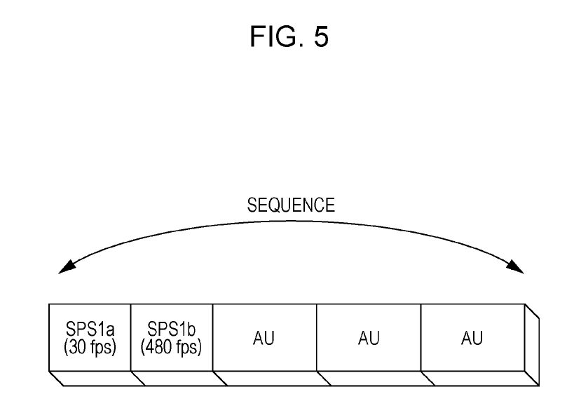

A specific method for detecting a video frame rate will be described. FIG. 5 is a diagram illustrating a data structure of H.264/SVC. Video data of H.264/SVC is formed of the unit called “sequence”. The sequence includes an SPS (sequence parameter set) and an AU (access unit). The SPS is a header in which information about encoding of a sequence is described. The AU is data obtained by encoding video itself.

In H.264/SVC, a plurality of SPSs can be arranged in one sequence as a mechanism of encoding multilayer video. That is, when decoding is performed by using an SPS in which low frame rate information is described, decoding can be performed to obtain video having a first frame rate, which is a low frame rate. In contrast, when an AU is decoded by using an SPS in which high frame rate information is described, decoding can be performed to obtain video having a second frame rate, which is a high frame rate.

The frame rate detecting unit 111 detects the value of the highest frame rate in the frame rate information of a plurality of SPSs. In the case of FIG. 5, 480 fps is detected. This is a process that is performed to detect video data having a video frame rate more suitable for a slow playback process as video data on which a slow playback process is to be executed.

The value of the video frame rate detected by the frame rate detecting unit 111 in step S406 is transmitted to the playback speed determining unit 110.

In step S407, the playback speed determining unit 110 determines a slow playback speed by using the value of the highest frame rate. This determination process is executed by referring to the playback speed information according to the above-described first embodiment. For example, since the highest frame rate is 480 fps, the slow playback speed is determined to be 1/16× speed.

In step S408, the playback speed determining unit 110 determines whether the video that is currently being played back is obtained by decoding the video having the highest frame rate detected in step S406 or not. Information about the video frame rate of the video that is currently being played back is obtained in step S403 when the playback speed is determined. By storing the information in the storage unit, the information can be used in step S408.

If the playback speed determining unit 110 determines that the frame rate of the video that is currently being played back is equal to the highest frame rate, the process proceeds to step S410. If the playback speed determining unit 110 determines that the frame rate is not equal to the highest frame rate, the process proceeds to step S409.

In step S409, the playback speed determining unit 110 instructs the decoding unit 104 to change the video frame rate to be decoded to the highest frame rate. Specifically, the playback speed determining unit 110 outputs, to the decoding unit 104, a command of ordering decoding AU using SPS of 480 fps.

In step S410, the decoding unit 104 executes selection and interpolation of output frames of video data that is currently being played back, and adjustment of output timing so as to realize the playback speed that is notified of using the control command transmitted from the playback speed determining unit 110. Accordingly, slow playback video corresponding to each frame rate can be provided to the user.

In this embodiment, a control command of specifying the slow playback speed determined in step S407 is transmitted from the playback speed determining unit 110 to the decoding unit 104. This command includes an instruction to perform playback at 1/16× speed with respect to the real time. In accordance with this instruction, the decoding unit 104 decodes video data so that the frame rate thereof is 480 fps, and executes a process of playing back the decoded video data at a playback frame rate of 60 fps, in order to play back the decoded video data at 1/16× speed. A method for realizing 1/16× speed has been described in the first embodiment, and thus the description thereof is omitted in this embodiment.

The process in steps S411 to S413 is similar to that in steps S208 to S210 described in the first embodiment, and thus the description thereof is omitted.

Step S414 is a process of instructing the decoding unit 104 to change the frame rate to the video frame rate determined in step S402 so as to perform again playback at the speed equal to the real time when the control unit 108 receives input of an instruction to stop slow playback in step S411. If the video frame rate is the highest frame rate before slow playback is performed, which means that the video frame rate determined in step S402 is the highest frame rate, and thus it is unnecessary to execute the process in step S414. After the process in step S414, the process returns to step S403.

According to this embodiment, in a case where video can be played back by selecting an arbitrary video frame rate from among a plurality of video frame rates, a video frame rate suitable for slow playback can be selected, and slow playback can be performed at a playback speed suitable for the video frame rate.

In this embodiment, a slow playback process is executed by using video data having a value of the highest video frame rate. Alternatively, video data having a value of a frame rate higher than the value of the frame rate of video data that is being played back at the speed equal to real time may be used. This is because, when slow playback at the same slow playback speed is performed on pieces of video data having a value of a frame rate higher than that of video data that is being played back at the speed equal to real time, smoother slow playback can be performed on the one having a higher frame rate.

In each of the above-described embodiments, the frame rate detecting unit 111 detects the value of a frame rate from video data, but may detect the value from metadata about the video. Specifically, the value of the frame rate may be detected from section data that is multiplexed on MPEG2 TS. In this case, the separating unit 103 separates section data, such as PSI/SI, from MPEG2 TS and outputs it to the frame rate detecting unit 111. The frame rate detecting unit 111 may analyze the input section data to detect the value of the frame rate.

Additionally, in each of the above-described embodiments, determination of a slow playback speed is executed by referring to the predetermined playback speed information. Alternatively, a slow playback speed may be obtained through calculation using the value of a frame rate. For example, a slow playback speed can be determined by dividing a predetermined value by the value of an obtained video frame rate. For example, the predetermined value is 30. This value is defined as the number of frames of video displayed per second during slow playback. That is, it is defined that playback is performed using 30 frames per second at any video frame rate. When the video frame rate is 60 fps, 30÷60=½, and thus slow playback is executed at ½× speed. On the other hand, when the video frame rate is 480 fps, 30÷480= 1/16, and thus slow playback is executed at 1/16 speed. In this way, a slow playback speed corresponding to a video frame rate can be determined in a calculation process.

### Third Embodiment

Next, a third embodiment of the present invention will be described. In the above-described first and second embodiments, one slow playback speed is set in accordance with a video frame rate. However, a plurality of slow playback speeds can be set, and a slow playback speed can be changed by a user operation.

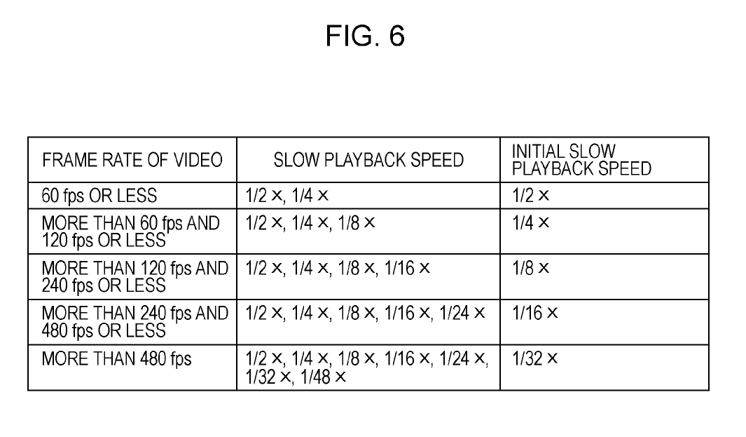

FIG. 6 is playback speed information specifying slow playback speeds that are predetermined in accordance with respective video frame rates. A plurality of slow playback speeds are specified compared to the playback speed information illustrated in FIG. 3. Also, initial slow playback speeds, which are set as default slow playback speeds when execution of slow playback is started in a state where playback is performed at the speed equal to real time, are separately specified.

For example, in the case of performing slow playback on video data having a video frame rate of 480 fps, the slow playback speed that is first specified by the playback speed determining unit 110 to the decoding unit 104 is 1/16× speed with respect to the real time. When a user performs a predetermined operation via the remote control while slow playback at 1/16× speed is being executed, a slow playback speed other than 1/16× speed (½× speed, ¼× speed, ⅛× speed, or 1/24× speed) can be selected.

Selection of a slow playback speed can be realized with a configuration in which a slow playback speed is sequentially switched in a low-speed direction or a high-speed direction when a user presses the slow playback button of the remote control. When the slow playback button is pressed again after ½× speed is selected, switching is performed so that slow playback is performed at 1/24× speed, so that a slow playback speed desired by the user can be selected with a simple operation.

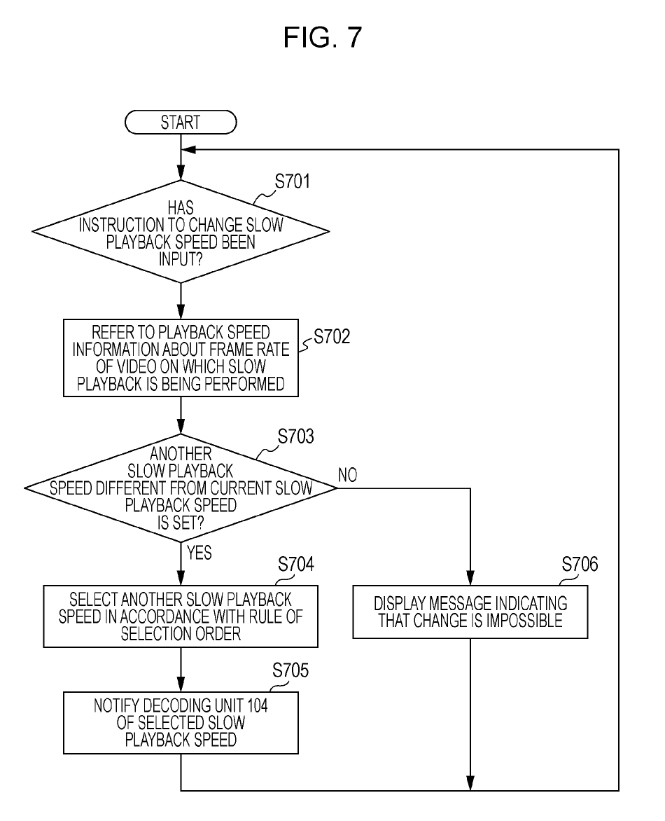

FIG. 7 is a flowchart illustrating switching control of slow playback speeds. This flowchart corresponds to an internal process that is executed in step S207 of the flowchart in the first embodiment illustrated in FIG. 2 and step S410 of the flowchart in the second embodiment illustrated in FIG. 4.

Additionally, assume that an initial slow playback speed in a determined video frame rate is selected and slow playback is executed in step S206 or step S407, which are steps before control according to this flowchart is executed. For example, in the first embodiment, when the video frame rate of video that is being played back is 60 fps, slow playback is performed at ½× speed. In the second embodiment, when the highest frame rate is 480 fps, slow playback is performed at 1/16× speed.

In step S701, the control unit 108 determines, in accordance with a notification from the remote control signal receiving unit 109 that receives a remote control signal, whether a user has input an instruction to change the slow playback speed via the remote control or not. If the control unit 108 determines that the instruction to change the slow playback speed has been received, the control unit 108 notifies the playback speed determining unit 110 of the information.

In step S702, the playback speed determining unit 110 refers to the playback speed information illustrated in FIG. 6 stored in the storage unit for the video frame rate of the video on which slow playback is being executed.

In step S703, the playback speed determining unit 110 determines, by using the playback speed information that was referred to, whether another slow playback speeds different from a playback speed of current slow playback is set for the video frame rate of the video on which slow playback is being executed. As a result of the determination in step S703, if it is determined that another slow playback speed does not exist, the process proceeds to step S706. The playback speed determining unit 110 notifies the control unit 108 of information for providing an instruction to combine a UI indicating that the slow playback speed is unchangeable with the video. The control unit 108 that has received the information generates a UI indicating that the slow playback speed is unchangeable and outputs it to the combining unit 106. The combining unit 106 combines the UI generated by the control unit 108 with the video that has been input to the combining unit 106.

If the playback speed determining unit 110 determines in step S703 that another slow playback speed different from the playback speed of the current slow playback is set, the process proceeds to step S704.

In step S704, the playback speed determining unit 110 selects a slow playback speed that is to be selected next to the current slow playback speed in accordance with a selection order of the slow playback speeds specified in the playback speed information. The information about the selection order is not illustrated in the playback speed information in FIG. 6, but preferably the selection order is ascending order of slow playback speed. Thus, in a case where a currently selected slow playback speed is 1/16× speed in a video frame rate of 480 fps, the slow playback speed that should be selected next to this playback speed is ⅛× speed.

In step S705, the playback speed determining unit 110 transmits a control command to the decoding unit 104 so as to play back video data at the slow playback speed determined in step S704.

In this embodiment, a plurality of slow playback speeds suitable for a video frame rate are set in accordance with the value of a video frame rate, and a user is allowed to arbitrarily select a slow playback speed. Accordingly, a video playback apparatus having an increased convenience for a user can be provided. Also, even in a case where a plurality of slow playback speeds exist, an initial slow playback speed that is applied at the transition to slow playback is set as a slow playback speed suitable for a frame rate of video. Accordingly, slow-motion video having a slow playback speed suitable for the frame rate can be presented to a user without changing the slow playback speed a number of times.

In addition, the elements and processes described in each of the above-described embodiments may be loaded as hardware, software, or the combination thereof. The software (program) for loading part or all of those elements and processes, and a storage medium storing the software are included in the scope of the present invention.

As described above, according to the present invention, a video playback apparatus capable of adaptively setting a speed of slow playback in accordance with the frame rate of video content that is being played back and performing slow playback suitable for the video content, and a method for controlling the same can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A video playback apparatus capable of performing a slow playback process on video data accumulated in an accumulation unit, the video playback apparatus comprising:
a detecting unit that detects a value of a frame rate of video data;
a determining unit that determines, on the basis of the value of the frame rate detected by the detecting unit, a slow playback speed used for performing slow playback on the video data having the frame rate; and
a playback unit that executes a slow playback process on the video data by using the slow playback speed determined by the determining unit.

2. The video playback apparatus according to claim 1,
wherein the video playback apparatus is capable of playing back video data at a speed equal to a speed in real time, and selecting, from among a plurality of pieces of video data having same content and different values of video frame rates, a piece of video data having any one of the video frame rates to play back the piece of video data,
wherein the detecting unit detects, at execution of a slow playback process, whether there exists video data that has a value of a frame rate higher than a value of a frame rate of video data being played back at a speed equal to a speed in real time and that has same content as the video data being played,
wherein the determining unit determines, if the detecting unit detects that there exists video data that has a higher frame rate and that has same content as the video data being played, a slow playback speed used for performing slow playback on the video data on the basis of the value of the frame rate of the video data, and
wherein the playback unit executes a slow playback process on the video data that has the higher frame rate by using the slow playback speed determined by the determining unit.

3. The video playback apparatus according to claim 1,
wherein the determining unit determines the slow playback speed of the video data on which a slow playback process is to be executed by using playback speed information in which at least one slow playback speed suitable for performing slow playback is associated with each of a plurality of values available as the frame rate of video data.

4. The video playback apparatus according to claim 3,
wherein, in a case where a plurality of slow playback speeds are associated with a value available as the frame rate of video data in the playback speed information, the plurality of slow playback speeds are slow playback speeds that can be selected in accordance with input of an instruction from a user at a time of slow playback of video data having an associated frame rate.

5. A method for controlling a video playback apparatus capable of performing a slow playback process on video data accumulated in an accumulation unit, the method comprising steps of:
detecting a value of a frame rate of video data;
determining, on the basis of the detected value of the frame rate, a slow playback speed used for performing slow playback on the video data having the frame rate; and
executing a slow playback process on the video data by using the determined slow playback speed.

6. The method for controlling a video playback apparatus according to claim 5,
wherein the video playback apparatus is capable of playing back video data at a speed equal to a speed in real time, and selecting, from among a plurality of pieces of video data having same content and different values of video frame rates, a piece of video data having any one of the video frame rates to play back the piece of video data,
wherein in the step of detecting, at execution of a slow playback process, whether there exists video data that has a value of a frame rate higher than a value of a frame rate of video data being played back at a speed equal to a speed in real time and that has same content as the video data being played is detected,
wherein in the step of determining, if video data having a higher frame rate and having same content as the video data being played exists, a slow playback speed used for performing slow playback on the video data is determined on the basis of the value of the frame rate of the video data, and
wherein in the step of executing, a slow playback process is executed on the video data that has the higher frame rate by using the determined slow playback speed.

7. The method for controlling a video playback apparatus according to claim 5,
wherein in the step of determining, the slow playback speed of the video data on which a slow playback process is to be executed is determined by using playback speed information in which at least one slow playback speed suitable for performing slow playback is associated with each of a plurality of values available as the frame rate of video data.

8. The method for controlling a video playback apparatus according to claim 7,
wherein, in a case where a plurality of slow playback speeds are associated with a value available as the frame rate of video data in the playback speed information, the plurality of slow playback speeds are slow playback speeds that can be selected in accordance with input of an instruction from a user at a time of slow playback of video data having an associated frame rate.

9. A video playback apparatus capable of playing back video data, the video playback apparatus comprising:
a playback unit that is capable of performing slow playback by using slow playback speeds, each of which is determined in accordance with the type of frame rate of video data,
wherein the slow playback speeds are determined so that slow playback at a slow playback speed corresponding to a second frame rate can be performed at a lower speed than slow playback at a slow playback speed corresponding to a first frame rate, the second frame rate being higher than the first frame rate.

10. A method for controlling a video playback apparatus capable of playing back video data, the method comprising a step of:
performing slow playback by using slow playback speeds, each of which is determined in accordance with the type of frame rate of video data,
wherein the slow playback speeds are determined so that slow playback at a slow playback speed corresponding to a second frame rate can be performed at a lower speed than slow playback at a slow playback speed corresponding to a first frame rate, the second frame rate being higher than the first frame rate.
